(19) United States
(12) Patent Application Publication
(10) Pub. No.: US 2010/0191565 A1
(43) Pub. Date: Jul. 29, 2010

(54) System and Method for Complying With TMSA Guidelines

(75) Inventors: Cynthia A. Hudson, Rydal, PA (US); Per W. Christensen, Rydal, PA (US); Timothy W. McLellan, Ridgefield, CT (US)

Correspondence Address: FOX ROTHSCHILD, LLP;Pittsburgh, 997 Lenox Drive, Bldg. #3, Lawrenceville, NJ, 08648, US

(73) Assignee: Hudson Marine Management Services, Pennsauken, NJ (US)

(21) Appl. No.: 12/358,391

(22) Filed: Jan. 23, 2009

(51) Int. Cl. G06Q 10/00; G06Q 50/00; G06F 17/30; G06F 15/16

(52) U.S. Cl. 705/9; 709/206; 707/E17.044; 715/224; 707/E17.009

(57) ABSTRACT

A system and method for complying with business procedures and tracking, for auditing purposes that the procedures are completed is disclosed. Specifically, the system is useful for tracking compliance with the Tanker Management and Self Assessment (TMSA) guidelines of the OCIMF, which deals with assessment of management and safety procedures for oil tankers. The system and method utilize both shore-based and ship-based computers which are synchronized when the ship-based computers are able to connect to the internet.

### BACKGROUND OF THE INVENTION

Oil companies have a vested interest in the safe shipping and terminalling of crude oil and oil products, and, as such, must perform proper due diligence in selecting well-maintained and well-managed vessels for charter. As a result, there is a need for a method of vetting carriers to determine if a carrier meets a minimum set of safety standards for a particular oil company. To avoid the necessity of carriers having to comply with different standards or vetting criteria for each oil company, is desirable that a standard be established that is accepted by a majority of the major oil companies.

The Oil Companies International Marine Forum (OCIMF) is a voluntary organization of oil companies that represent the interests of oil companies on such matters. The OCIMF has established a program called the Tanker Management Self Assessment (TMSA), introduced in 2004, as a tool to help carriers assess, measure and improve their vessel management systems. This allows the carriers to demonstrate a level of compliance and to establish a TMSA rating that may be used by oil companies to vet the carriers.

The TMSA is broken down into twelve elements that cover all aspects of a carrier's operations. For each element of the TMSA, a set of key performance indicators (KPI) are defined, along with best practices to meet the KPI goals. This allows the carriers to achieve high levels of quality in ship management procedures, put in place plans for continuous improvement and perform self assessments to measure progress against established goals. TMSA also provides a means for rating the carriers, to allow the oil companies to achieve a level of confidence that the vessels carrying its products are well managed and maintained, and that the carriers are achieving satisfactory tanker quality and ship safety standards. The TMSA manual, ISBN 1856092844, is incorporated herein by reference and may be referred to for more details regarding the TMSA.

One problem with the TMSA and the carriers' compliance with it is that the manner in which the key performance indicators are met and the way that the best practices are implemented may be different for each carrier. In other words, there is no standard method of compliance. Each carrier is required to develop its own procedures for compliance with the TMSA. Compliance invariably involves the filling out and filing of forms to track incidents, actions, procedures, etc. Forms may also have different sections that need to be filled out by different people who may be aboard a vessel or on shore. In addition, when internal or external audits are performed, the collection of material and information necessary to perform the audit may require many hours of effort. As such, a manually implemented TMSA program can quickly become overburdening to the carrier.

It would therefore be desirable to provide a way to ease the burden on the carriers of compliance with the TMSA, to provide automated methods of compliance and standardized forms acceptable to both the carrier and the oil companies.

### SUMMARY OF THE INVENTION

The present invention is a system and method that provides the means for implementing the TMSA guidelines through a dynamic set of forms, robust reports, role-based workflow, task management, and document management, having components both on shore and at sea.

The system is a web-based technology that establishes a set of procedures and forms, provides a programmed workflow to oversee the execution of the established procedures and the completion of the proper paperwork. The programmed workflow is role-based, meaning that a set of tasks is assigned to a person fulfilling a particular role, either on board a vessel or on-shore, such as the captain of a particular ship. The system also provides for the efficient management of documents, such that all required documents are available and retrievable for internal and external audits.

The system works between vessels at sea and shore-based operations and is able to synchronize workflows across the land-sea barrier. The web-based interface works over the internet on shore and each vessel is provided with an on board server serving the appropriate web pages while the vessel is at sea and without internet access. The system communicates and synchronizes between the shore and vessels via emails when the vessel is within communications distance of the shore and is able to establish a data connection. A central repository of completed documents is kept in a centralized, on shore database for easy access and retrieval.

### DESCRIPTIONS OF THE DRAWINGS

FIG. 1 shows is a schematic view of the physical setup of the system of the present invention

FIG. 2 shows a system level diagram of the present invention.

FIG. 3 is a data flow diagram for the described system.

FIG. 4 shows a logon screen.

FIG. 5 shows a screen wherein forms and checklists may be selected.

FIG. 6 shows the screen where an example form is shown.

FIG. 7 shows the functions that can be performed on forms.

FIG. 8 shows the screen from which tasks to be display can be selected.

FIG. 9 shows a list of notifications for a specific user.

FIG. 10 shows a set of rules for an example workflow associated with a particular form

FIG. 11 is a diagram showing the workflow from FIG. 10.

FIG. 11 shows the screen for which reports and documentation may be selected.

FIG. 13 shows the screen wherein specific reports selection criteria may be entered.

FIG. 14 shows a report rendered in graphical and tabular formats,

FIG. 15 shows one screen of the TMSA audit function.

FIG. 16 the screen from which TMSA manuals may be selected for display.

FIG. 17 shows the screen where internal procedures and external procedures manuals may be selected for display.

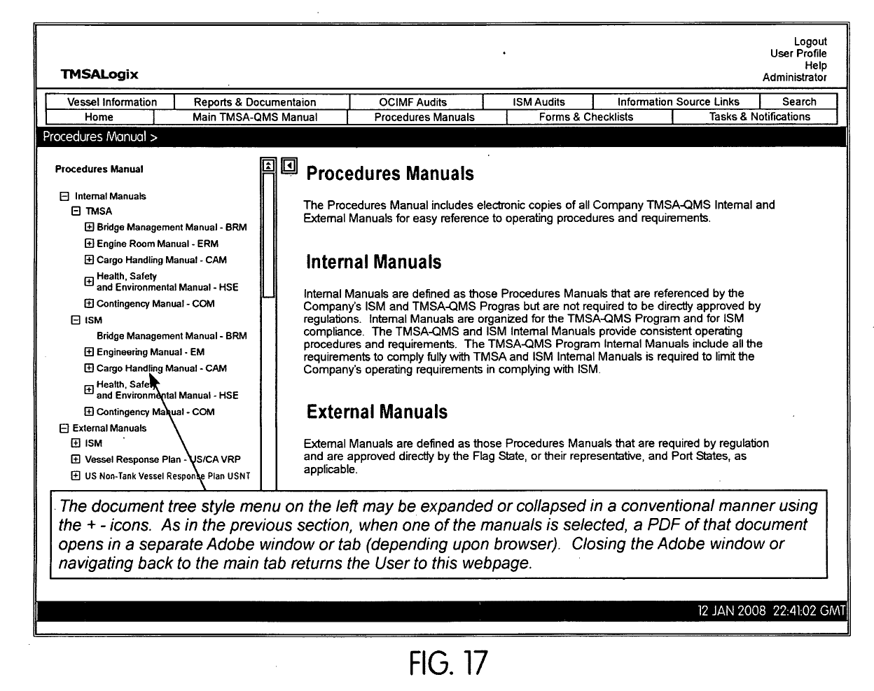

### DETAILED DESCRIPTION

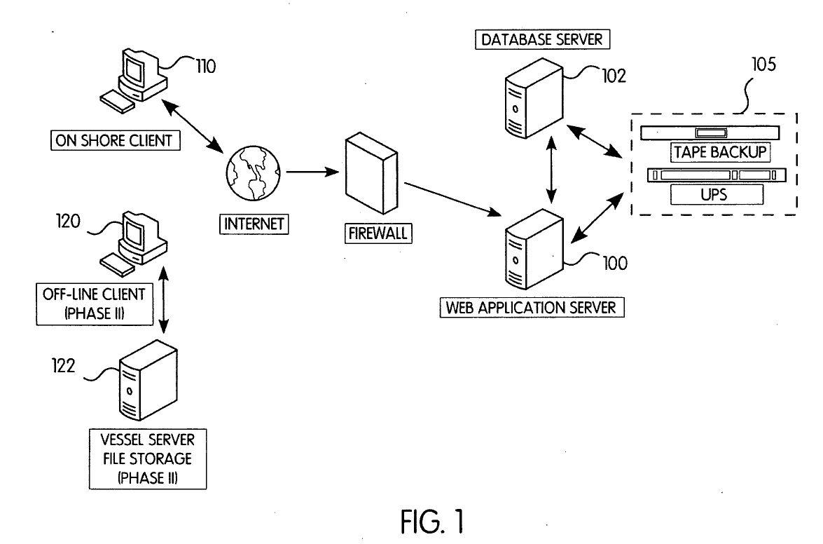

FIG. 1 shows a typical physical system upon which the present invention may be run. Because this system is web-based, it is accessed by clients as a web page, either via the internet, for on shore operations, or via an intranet, for operations on board vessels at sea. Web/application server 100 and database server 100 act as the central node for all onshore operations, and physically may be a typical computer suitable for serving web pages and acting as a database server respectively. These systems may be shared by many carriers and maintained by a central administrator, or they may be specific to a single carrier. These systems are typically behind a firewall and are accessible over the internet, preferably with a constant connection.

The users of the system are divided into two distinct types. First is the on-shore user 110, who may access the web/application server 100 and database server 102 at any time via a standard internet connection. The second type of user is the on-board or off-shore user 120, who is typically physically located on an oil tanker or other similar type vessel which is at sea for extended periods of time without access to the internet. In such cases, the vessel is equipped with a local server and file storage database 122 and the application may be access via a ship-wide intranet. The on-board server 122 will serve the same application as on-shore web server 100 such that a client running the application on-shore or on-board a vessel would not notice a difference in operation. The on-board database in file storage computer 122 stores changes made to the database while the vessel is at sea, and is synchronized with the database on database server 102 via emails containing attached XML files or whenever the vessel has access to the internet, such as when it is in port. Web application server 100 and database server 102 also are attached to tape backup and uninterruptible power supply 105 for continuous operation. On-board computer 122 is connected to an external hard drive for backup operations for that particular vessel.

The computers acting as servers 100, 102, and 122 are typical PCs of the type used as file servers or web servers in any business application. Client computers 100, 110, and 120 are typical personal computers having a web browser to access internet web pages.

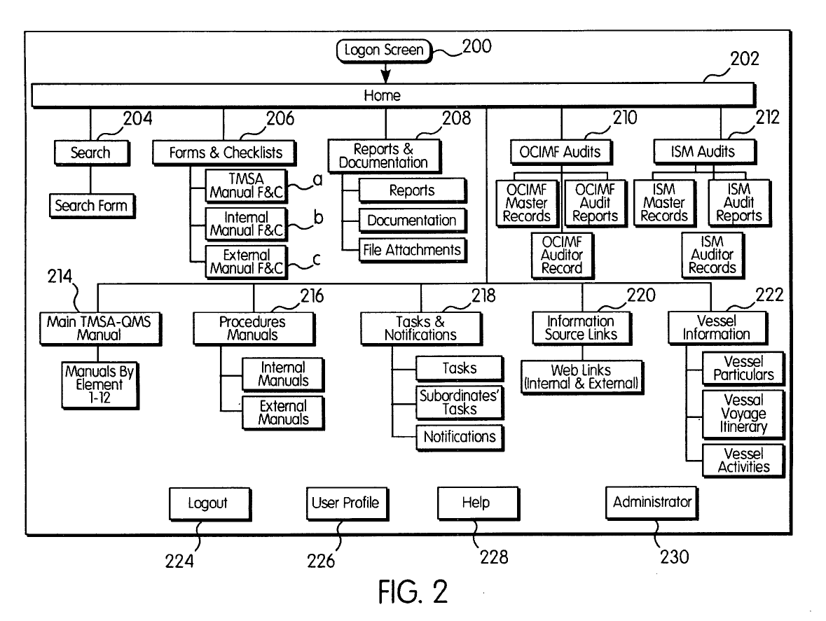

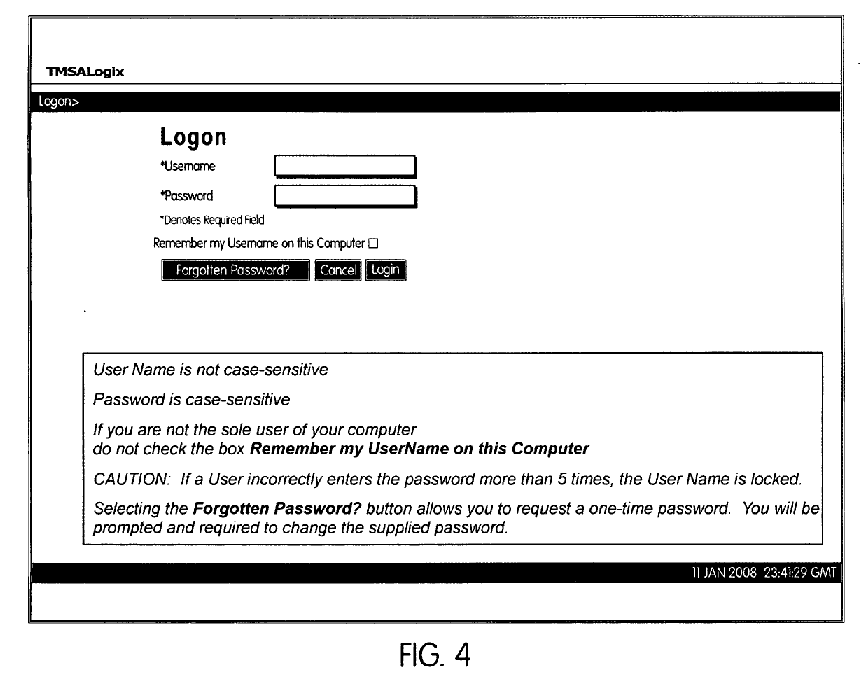

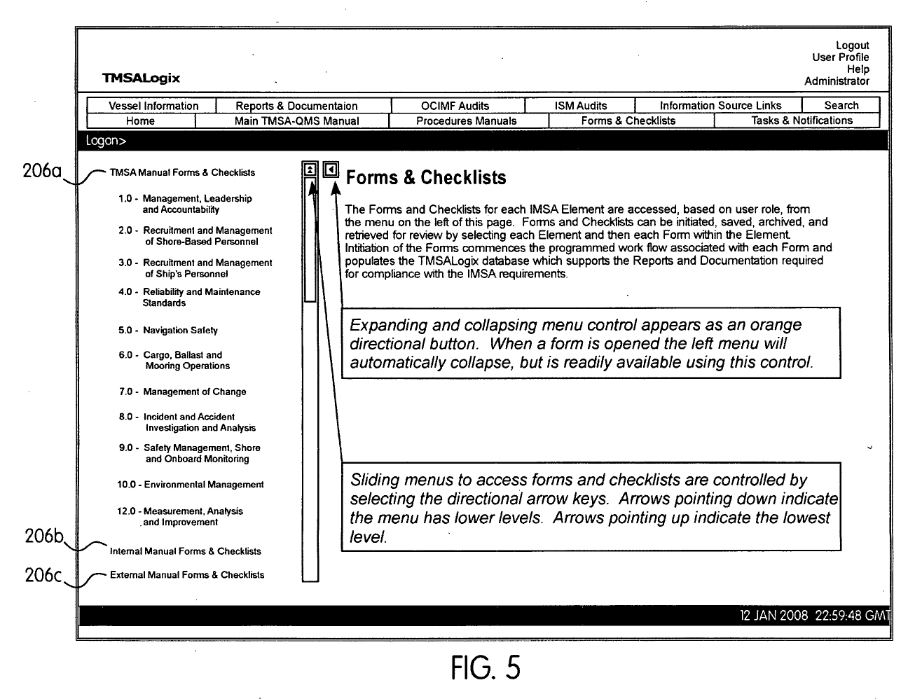

FIG. 2 shows a system map of the application which is served by web/application server 100 and also by vessel server 122. The first screen encountered by a user is a log-on screen 200 which requires the user to enter a user name and password to access portions of the database on database server 102. The log-on screen is shown in FIG. 4. After successfully entering the user's user name and password, the user is granted access to the system and is presented with the home page 202. Home page 202 has a plurality of tabs along the top of the screen as shown in FIG. 5, allowing access to various sections of the application's functionality. Access to the tabs is role based, therefore, some users may or may not be able to access all the tabs in the system. These sections are also shown in the system map in FIG. 2 and will be explained fully later.

FIG. 5 shows the main page of the TMSA application showing the forms and checklist tab 206. The forms and checklist are broken down into three separation portions. The TMSA forms and checklist 206a, internal manual forms and checklists 206b, and external manual forms and checklists 206c. FIG. 5 shows the TMSA Manual Forms and Checklists 206a in expanded form showing twelve numbered sections under the TMSA Manual Forms and Checklist menu item. The twelve sections correspond to the twelve elements of the TMSA best practice guide for ship operators, as outlined in the TMSA manual published by the OCIMF. The twelve elements of the TMSA guidelines represent twelve separate areas of on-board and on-shore operations which must be managed by the carrier operators under the TMSA guidelines. Under each of the twelve elements of the TMSA are forms and checklists applicable to that particular element of the TMSA.

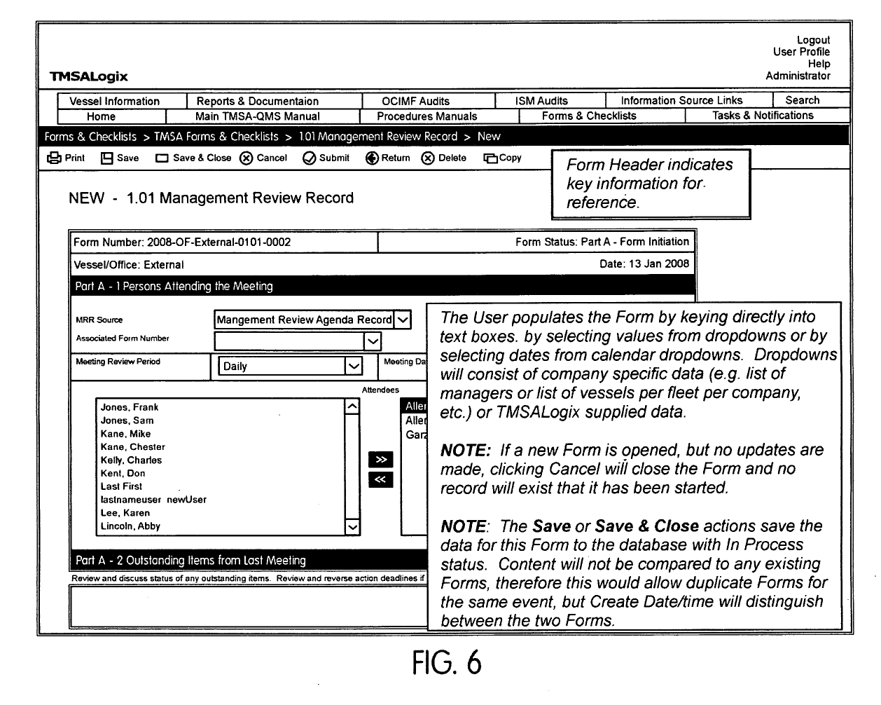

FIG. 6 shows an exemplary form selected from element 1 of the TMSA Manual Forms and Checklist section 206a, which deals with management, leadership. This form is shown as an example only and is typical as to look and feel of all forms with the application. Note that the forms are not specified by the TMSA guidelines but are typically forms which the carriers have created to comply with the TMSA guidelines. The web application comes with a set of predefined forms which may be used to fulfill the requirements of the TMSA guidelines.

Note that not all users will be able to access every different type of form under the twelve elements of the TMSA. Users, when they are registered with the system, are assigned a particular role. The role would typically be, for example, the master of the ship or ship's engineer for on-board personnel or safety officer for on-shore personnel. Each particular role will typically only be filling out a subset of all of the forms which are available. In addition, a form may require multiple personnel fulfilling multiple roles to enter information into the same form. As such, a workflow is associated with the form and is activated when the form is initiated. The workflow specifies tasks requiring personnel fulfilling certain roles to fill out specific section(s) of the form he or she is responsible for. Once a particular user has entered the required information, he or she saves the form by electronically signing his section of the form and the form is routed to the next person who must enter information into the form, based on a form-specific set of rules. This continues until all necessary information has been entered into the form and the form is complete.

Some portions of each form may come pre-filled in by the system. For example forms which are typically filled out by on-board personnel may, when they are initiated, already have some information filled in, such as the name of the vessel and other such information pre-entered into the form.

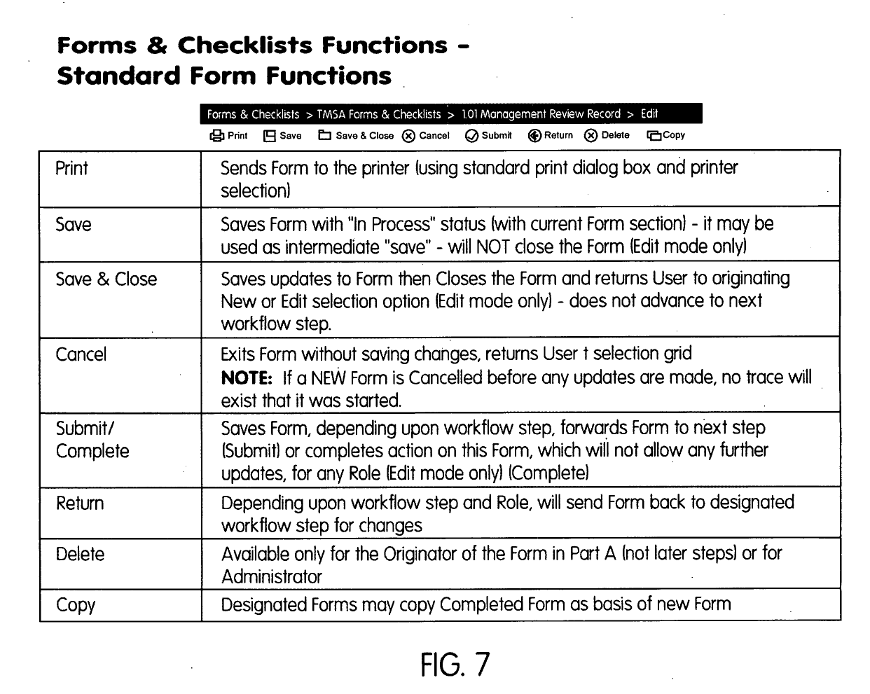

FIG. 7 shows various functions which may be accessed via the menu bar at the top of the forms page which allows the user to perform various tasks with respect to the form. Of particular interest are the submit/complete function 700 and the return function 702. With respect to the submit/complete function, once a user has entered his or her required information into the form the form may be submitted by clicking on the submit function. The submit function saves the form and indicates to the workflow manager that the form may be passed to the next person in the defined workflow for that form, who may be required to enter information onto the form or complete some action with respect to the form. The submit function also checks to make sure that all “required” fields are properly filled. If there are any required fields that need data, the submit function will alert the user of such and will not advance to the next workflow step. In any case, once the user has invoked the submit/complete function that particular user in that particular role is unable to make further changes to the form. Return button 702 allows the user to send the form back one step in the workflow. This button is typically used if the user notices that changes must be made in the form or if the form is incomplete. The remainder of the functions available in the forms and checklist menu bar perform the typical function that would be expected of the button.

Referring back to FIG. 5, the other menu items on the left side of the screen, Internal Manual Forms and Checklists 206b and External Manual Forms and Checklists 206c perform similar functions. Internal Manual Forms and Checklists 206b will present a list of forms and checklists which are specific to the particular carrier and which may involve procedures which may or may not be performed in support of the TMSA guidelines. External Manual Forms and Checklists button 206c will present a list of forms and checklists which are required by various outside entities, such as by port authorities or flag states.

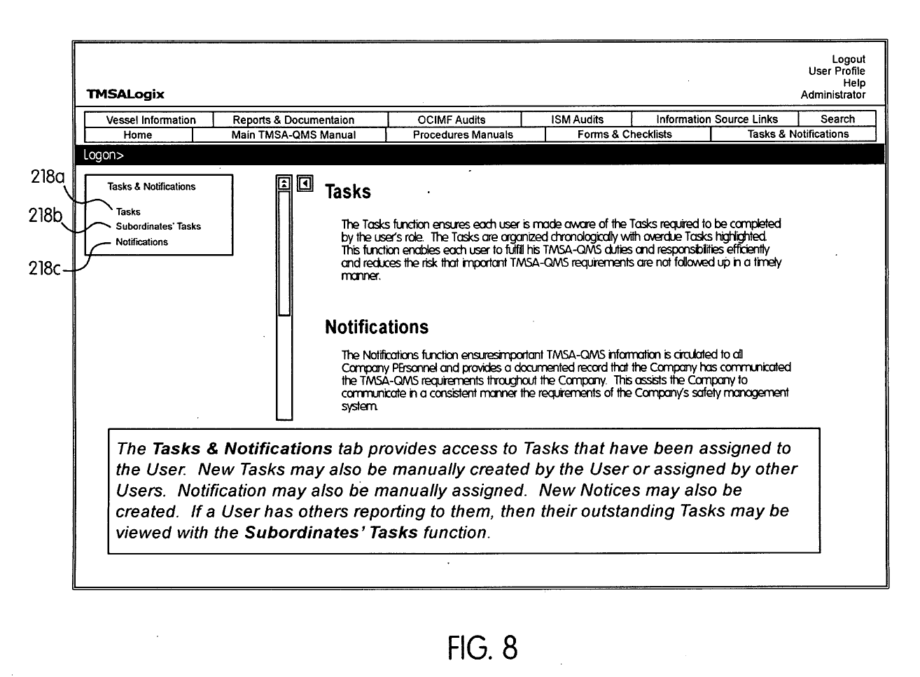

FIG. 8 shows the tasks and notifications tab from the TMSA web application's main screen corresponding to reference number 218 in the system map of FIG. 2. The task assigned to a particular user is dependent upon the role that user fulfills within the system and upon which workflows are currently active. A workflow may be initiated, for example, by selecting a new form which must be completed. The system is aware, based upon the particular form selected, which roles and which persons fulfilling those roles are required to complete the form. Once the form is started, a task to complete his or her section of the form is added to the task list of each user who is required to add information to the form when the form reaches the particular step in the workflow where the user's role is assigned.

The tasks in each user's task list may be displayed by selecting the tasks button to 218a. Once a task has been completed by the user, for example, by filling in the form and selecting the submit/complete function 700 from FIG. 7, the task is removed from the user's task list. The user may also choose to view tasks which must be completed by his or her subordinates by selecting subordinates task button 218b.

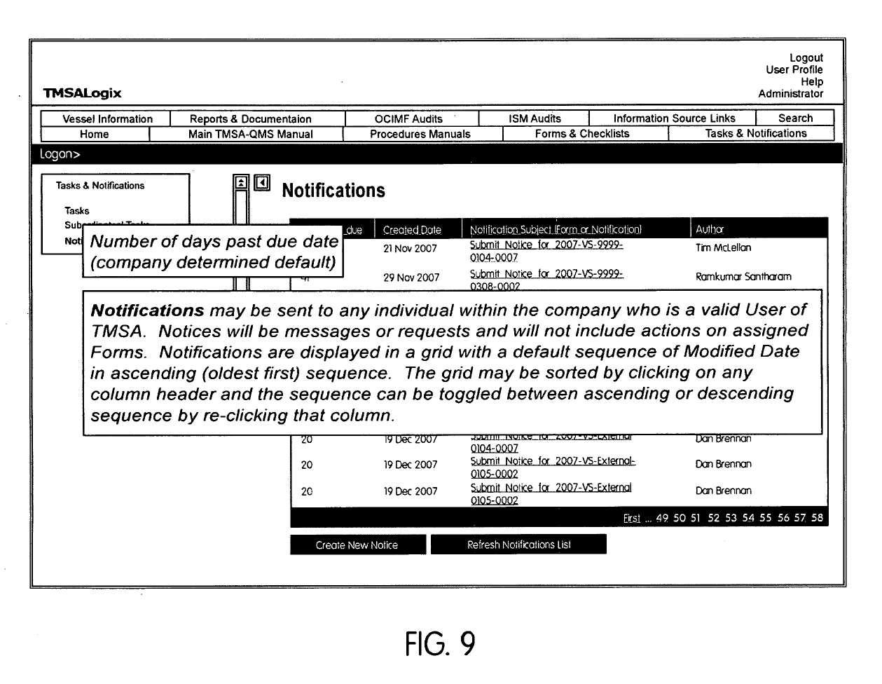

The user may also receive certain notifications regarding the TMSA or other matters by selecting a notifications button 218c shown on FIG. 8. Once a user reads a notification an audit trail is provided showing that the information had been made available to all persons whose particular defined role requires that they know that particular type of information. The typical notification screen is shown in FIG. 9. The notifications for a person fulfilling a particular role may include messages and requests but will not include actions the user is required to take with respect to filling in information on forms.

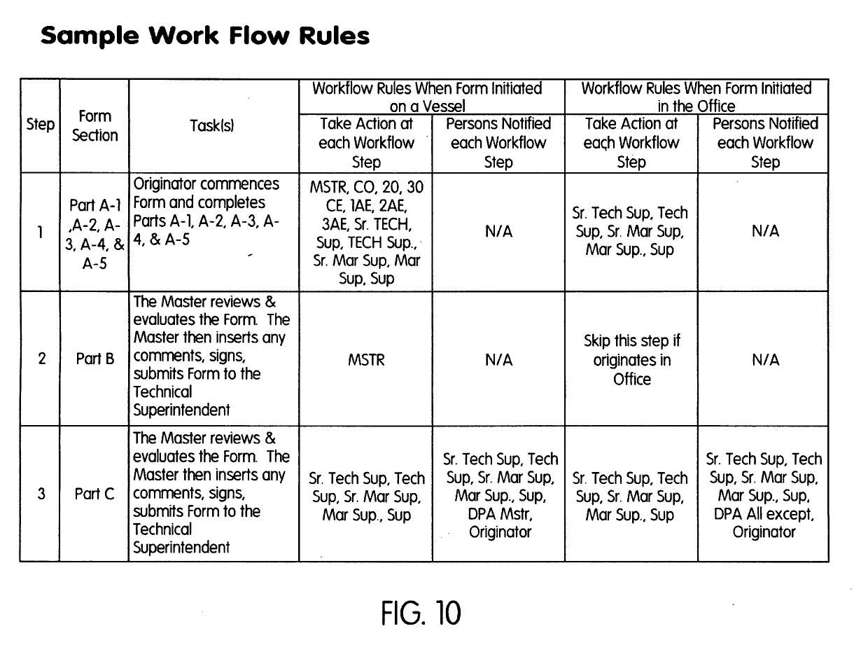

FIG. 10 shows the workflow rules for a typical form. In the example, shown, the form has three parts which must be filled out and tasks defined for each of the three parts. There are also rules defined for each section of the form depending upon whether the form has been initiated on-board a vessel or on-shore and includes persons who must take action at each workflow step and persons who are to receive notifications at each workflow step. For the particular form shown, the originator initiates the form and completes several sections in Part A. The form is then passed to the Master who is tasked with reviewing and evaluating the form and entering comments in Part B. Once the Master has completed his required entries, the form is passed to the next set of roles, such as the Technical Superintendent, who is required to complete Part C of the form and to check and sign the form as complete.

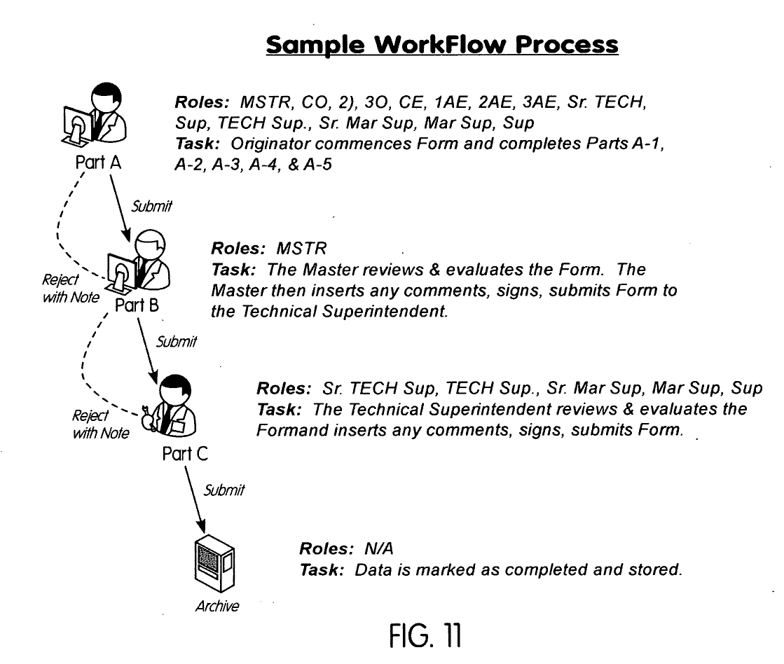

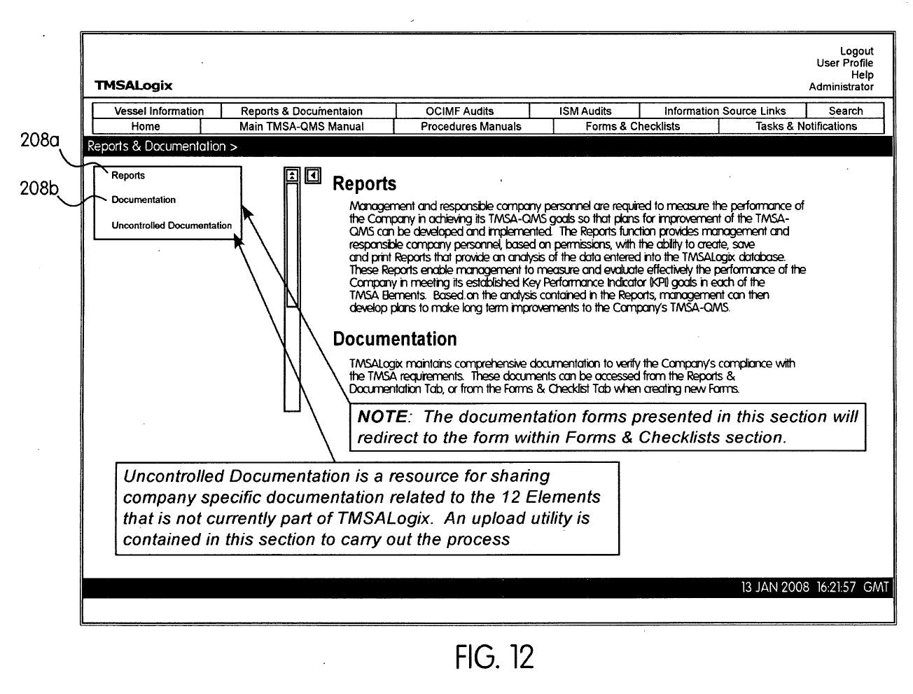

The workflow process for this form is shown in FIG. 11. Part A of the form shows the roles which are involved and the tasks which must be completed. For the tasks, the originator starts the form and completes Parts A-1 through A-5. The user then submits the form for the next step. The tasks for step B involves the master reviewing and evaluating the form then inserting any comments, signing the form, and submitting the form to the technical superintendent. The master may also reject the form back to the originator of the form with a note requesting a change in the form. Once the master is completed with Part B of the form he submits the form for submission to the technical superintendent. The technical superintendent then is responsible for Part C of the form where the technical superintendent reviews and evaluates the form and inserts any comments, signs, and submits the form. The form is now complete and the data is archived in database servers 102 and 122 and the form is marked as completed. An audit trail is created at each step of the process.

Referring back to FIG. 2, Section 208 deals with reports and documentation. The screen showing the reports and documentation tab is shown in FIG. 12. The reports and documentations section allow the carrier's personnel to measure the performance of the company in achieving its TMSA goals and to provide documentation proving compliance with various aspects of the TMSA.

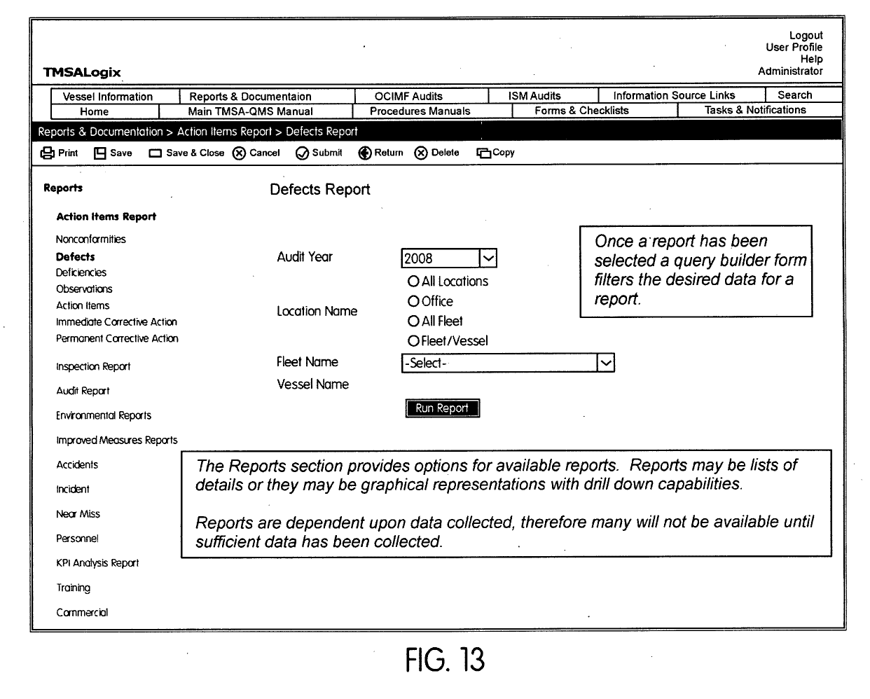

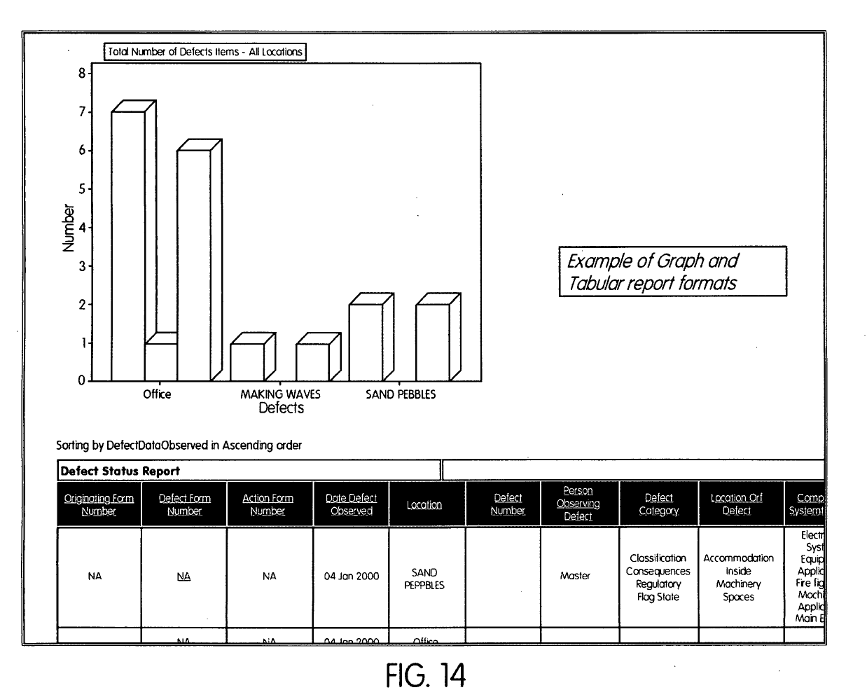

Referring to FIG. 12, the TMSA reports can be accessed from the pull down menu 208a, and supporting documentation can be accessed from pull down menu 208b. Reports generated by the reports section of the web application may require compilation of data from many different forms which have been filled out during the course of normal operations of the carrier. For example reports summarizing the number of injuries occurring on-board the carrier's vessels over the past year will require data entered from forms which should have been completed based upon each incident and summarized in the requested report. The screen for selecting reports is shown in FIG. 13, which displays an exemplary list of various different types of reports down the left side of the screen. As an example, FIG. 13 shows the selection of a “Defects” report and the user may be able to customize the report using the parameter selection options shown on the page. The user then runs the report by clicking the run report button, and the report is generated. Reports may be summary formats or they may be graphical or tabular report formats as shown in FIG. 14.

Referring back to FIG. 12, the user may also select documentation which may be used as supporting proof of the carrier's compliance with various TMSA requirements. This is especially important during the audit process which will be discussed later. Documents, for example, may include completed forms which have been saved to database 102.

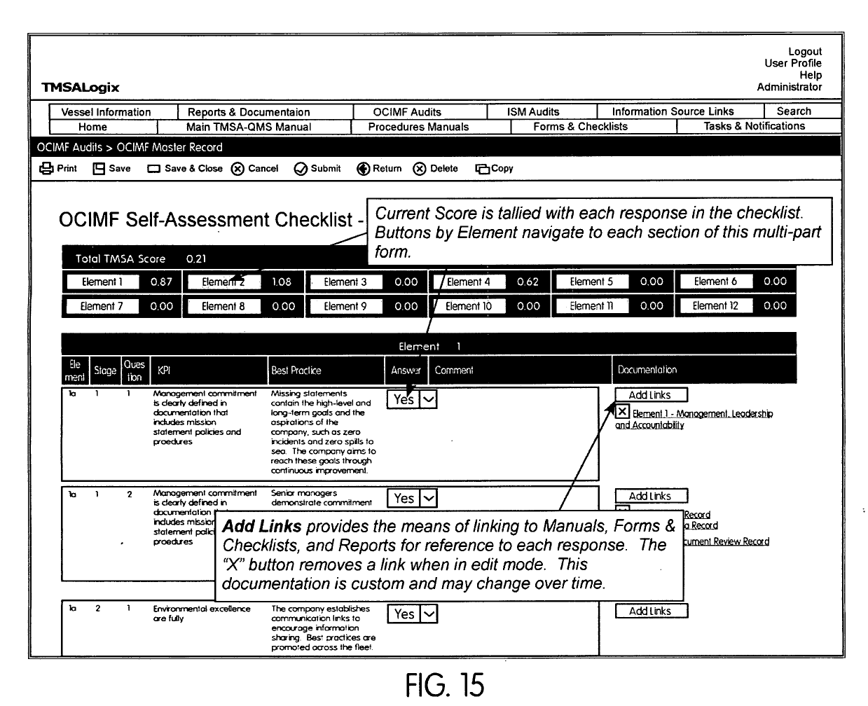

FIG. 15 shows the screen used to perform audits which measure compliance with the TMSA, also shown as reference number 210 in FIG. 2. Audits may be performed internally by the carrier's personnel to perform self-assessments. These audits may be reviewed by external auditors from the various oil companies or from OCIMF. FIG. 15 shows the twelve elements of the TMSA across the top of the screen, with an audit score for each element. The scores for each element are based upon the answers given to various questions asked for each element. The scores for each element are then composited into a total TMSA score, which is also shown on the screen at FIG. 15. The types of questions which must be answered are based upon the best practices defined in the TMSA for each element. The user either answers yes or no depending upon whether the best practice was executed to meet the goals of the TMSA. Comments may also be entered as well as supporting documentation via links to documents such as reports or completed forms and checklists. Once the questions have been answered for each of the elements of the TMSA, the composite score will represent the TMSA score which may be used by oil companies to vet the carrier and may determine whether the carrier receives charters from various oil companies. The various oil companies may accept scores at different levels to certify the carrier for charter.

Reference number 212 on FIG. 2 shows that another type of audit may be performed. The ISM (International Safety Management) is a standard enforced by the flag states that all international vessels must adhere to, the purpose of which is to provide an international standard for the safe management and operation of ships and for pollution prevention. The ISM standard, however, does not take into consideration process put into place to improve safety standards, nor does it track continuous improvement. As such, the standard is not suitable for oil companies to utilize to vet carriers. The present invention was developed taking the ISM and TMSA standards into consideration to create an integrated system where TMSA is a superset of the ISM standards. Although TMSA is a more comprehensive standard, ISM compliance is still required. Therefore, the ISM requirements checklist is maintained separately for auditing purposes only. In the ISM checklist, the user indicates whether or not the vessel has adhered to the ISM standards and allows them to link to the same forms and checklists used throughout the TMSA portion of the application.

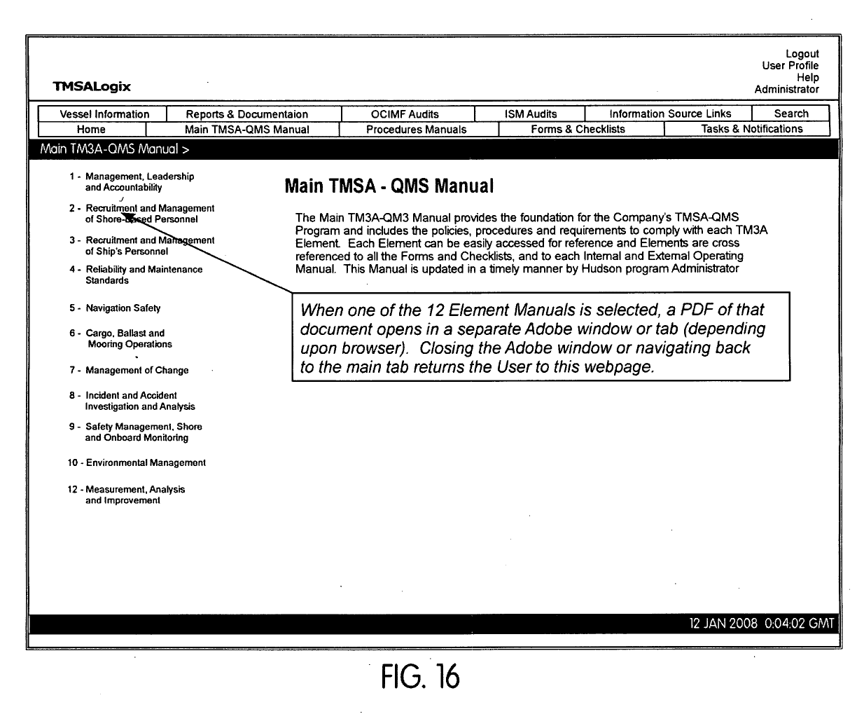

Section 214 of the system as shown on FIG. 2 provides the main TMSA manual which includes the policies, procedures, and requirements to comply with each TMSA element. The screen for accessing the manual may be found in FIG. 16. Each manual provides the procedures which allow the carrier to comply with a particular best practices of the TMSA and it includes cross references to the forms and checklists which must be filled out as part of that compliance. The main TMSA manual may include a description of incidents, actions or events which require the completion of a form with procedures that must be carried out and instructions on how to complete the forms. The workflow for each form may also be provided. Forms may be initiated by clicking on embedded links within the manuals.

Section 216 in FIG. 2 provides for the cataloging and display of both internal 216a and external 216b manuals separate and apart from the main TMSA manual of Section 214. The internal manuals 216a are carrier-specific procedures manuals which are not required to be approved by regulations. Manuals geared toward compliance with both the TMSA and the ISM may be included in this section. These manuals are not strictly based upon TMSA elements but instead are the internal operating procedures put in place by the carrier. The external manuals 216b are those manuals that are required to be on-board the vessel and which are required by the flag state of the vessel or by the port authorities of the ports which the vessel may visit.

Section 204 on FIG. 2 is a search facility that allows for the searching of all forms, including those which have already been completed based upon a set of search criteria which may be entered by the user. Section 220 provides external web links to various information sources that may be useful for the operators of the vessels and for on-shore personnel. Section 222 provides vessel information, which may include vessel particulars such as vessel name, dimensions, carrying capacity, etc. and may also include various itineraries of the vessel and various activities that may be occurring on the vessel. The on-board web server may have access to only the vessel information for the particular vessel part of which is located however the vessel information for the system on the shore has information for all vessels within the fleet.

Functions 224-232 provide various miscellaneous functions within the web application and are accessed via buttons located in the upper right hand corner of the main web application screen. Button 224 allows a particular user to log off from the system; button 228 allows the user to update his or her user profile including specific information regarding the user; button 230 provides the help function for the system; and, button 232 provides an administrative section where the system administrator can make changes to certain settings within the program for example, to assign users to various roles.

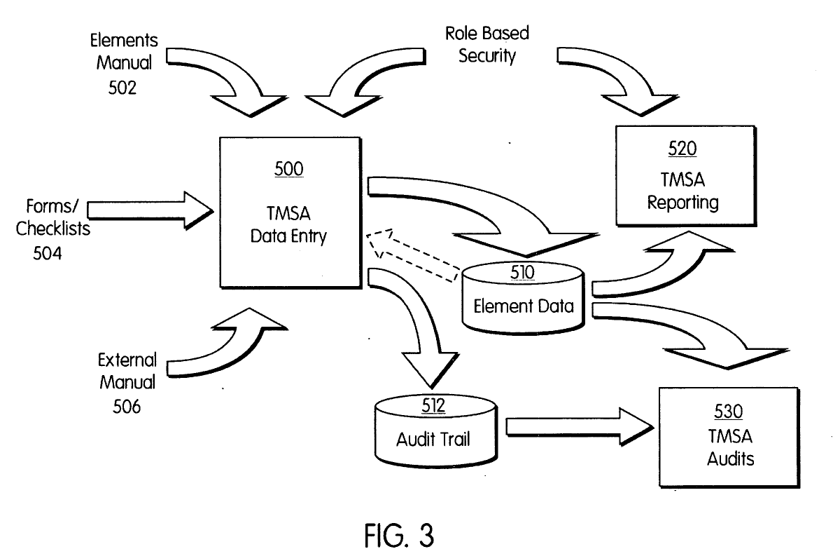

FIG. 3 shows a data flow diagram for the entire TMSA web application. The application itself is shown in the middle of the diagram and is labeled 500. Various data elements flow into the application including elements manuals 502, forms and checklists 505, and external manuals 506. In addition, the information regarding role-based security is use to enforce access restrictions based upon a user's particular role. This includes information about which roles are able to access certain parts of the system and are able to run certain types of reports.

Element data is kept in element database 510 and includes information supplied by users during the fulfillment of the various forms which are required to be filled out. Element data 510 is used by the TMSA reporting function 520. The TMSA reports are utilized by internal management of the carriers to determine their progress against the various key performance indicators of the TMSA and to ensure that constant improvement is occurring.

There is also an audit trail database 512 which includes information that may be used as proof that various tasks have been completed. For example, when a notification is sent out, the audit trail may include indications of when the notification was read by each of the persons to which it was sent. The audit trial may also track the timeliness of the completion of reports for various activities and incidents. The audit trail database 512 is actually used in the completion of the TMSA audits, both internal and external, as documentation supporting the assertion that various key performance indicator goals have been met.

The systems and functionality described are exemplary in nature and are not intended to be limiting as to the scope of the invention. Various other hardware configurations could be used without departing from the scope of the invention. Likewise, the software component has been shown as being broken down into modules that perform various functions. It is recognized that many different implementations of the software could be created which result in different modularizations, however, the scope of the invention is meant to be defined by the functionality as opposed to actual implementations of the functionality.

We claim:

1. A system for implementing a quality management system comprising:
a. a computer capable of acting as a web server; and
b. a software component, implemented as a served web page on said computer, said software comprising:
a forms module, said forms module allowing the electronic display and completion of forms, and the activation of a rules-based workflow associated with each of said forms; and
a task management module, said task management module analyzing said active workflows and notifying one or more individuals of tasks that need to be completed at each step of said active workflow.

2. The system of claim 1 further comprising a database for storing information entered into instances of created forms, and information regarding active workflows.

3. The system of claim 2 wherein said software component further comprises a reports module, said reports module extracting information from said database and compiling reports based on a user-entered data-selection criteria.

4. The system of claim 3 wherein said software component further comprises an audit module, said audit module providing an analysis of activities by users of said software component.

5. The system of claim 4 wherein said software component provides a notification facility to users of said system, said audit module providing a timestamp when said users have read said notifications.

6. The system of claim 5 wherein said workflows are role-based, and further wherein a user of said system may be assigned one or more roles.

7. The system of claim 6 wherein said users assigned to certain roles receive notifications of tasks in a workflow which must be completed.

8. The system of claim 7 wherein said workflows are broken down into various steps, each step containing one or more tasks that each of which must be completed by a person assigned to a specific role, and further wherein tasks for one step are not assigned until the tasks in the previous step have been completed.

9. The system of claim 8 wherein said users assigned to specific roles may indicate their completion of a specific task.

10. The system of claim 8 wherein said software component further comprises a manuals module, said manuals module being capable of displaying manuals describing said tasks, said manuals having links to forms managed by said forms module, such that a new versions of a form required for a task may be initiated from said manuals module.

11. The system of claim 2 wherein two or more of said computers are running said software component, and at least one of said two or more computers has a constant connection to the internet.

12. The system of claim 11 wherein one or more of said computers not having a constant connection to the internet may be connected to the internet at intervals during which changes made to the database on any computer are synchronized with at least one of said computers having a constant internet connection.

13. The system of claim 12 wherein said synchronization occurs through the exchange of email messages between said two or more computers.

14. The system of claim 13 wherein said email messages have attached XML files containing information necessary to synchronize said databases.

15. A system for implementing a TMSA compliant management system comprising:
a. at least one shore-based computer capable of acting as a web server and having a connection to the internet;
b. at least one ship-based computer capable of acting as a web server and being able to connect to the internet at least when said ship is docked; and
c. a software component, running on each of said shore-based and said ship-base computers, said software component being implemented as a served web page on said computers, said software comprising:
a forms module, said forms module allowing the electronic display and completion of forms, and the activation of a workflow associated with each of said forms;
a task management module, said task management module analyzing said active workflows and notifying one or more individuals of tasks that need to be completed at each step of said active workflow; and
a database for storing information entered into instances of created forms, and information regarding active workflows.

16. The system of claim 15 wherein one or more of said ship-based computers synchronizes its database with one or more of said shore-based computers when said ship-based computer is able to connect to the internet.

17. The system of claim 16 wherein said synchronization occurs through the exchange of email messages between said ship-based computers and said shore-based computers, said email messages having attached XML files containing information necessary to synchronize said databases.

18. The system of claim 15 wherein said workflows are role-based, and further wherein users of said system may be assigned one or more roles.

19. The system of claim 18 wherein said users assigned to certain roles receive notifications of tasks in a workflow which must be completed.

20. The system of claim 19 wherein said workflows are broken down into various steps, each step containing one or more tasks that each of which must be completed by a person assigned to a specific role, and further wherein tasks for one step are not assigned until the tasks in the previous step have been completed.

21. The system of claim 20 wherein said users assigned to specific roles may indicate their completion of a specific task.

22. A method of complying with TMSA guidelines comprising:
a. providing, on one or computers, a facility for the electronic display and completion of forms;
b. activating a rules-based workflow associated with a form, when a new form is initiated;
c. analyzing said active workflows;
d. notifying one or more individuals, via said one or more computers, of tasks that need to be completed at each step of said active workflow; and
e. electronically storing information entered into instances of created forms, and information regarding active workflows.

23. The system of claim 22 wherein two or more computers are used, at least one of which has a constant connection to the internet and at least one of which is connected to the internet at intervals, further comprising the step of synchronizing the electronically stored information on said two or more computers.

24. The system of claim 23 wherein said synchronization step further comprises the step of exchanging email messages between said two or more computers, said email messages having attached XML files containing information necessary to synchronize said information.

25. The system of claim 22 wherein said workflows are role-based, further comprising the step of assigning a user of said system to one or more specific roles.

26. The system of claim 25 wherein said notifying step comprises notifying users assigned to specific roles that a task must be completed within a workflow having defined tasks for specific roles.

27. The system of claim 26 further comprising the step of tracking the tasks required for each step of a workflow, and waiting to assign further tasks in a workflow until all of said tasks for a given step within said workflow are completed.

28. The method of claim 27 further comprising the step of providing an audit function, said audit function comprising the steps of:
a. asking a series of questions to the user;
b. allowing said user to supply links to documents in support of said user's answers to said questions; and
c. compiling a score based on said user's answers to said series of questions.

29. The method of claim 27 further comprising the steps of:
a. sending informational notifications to users in specific roles;
b. tracking when said users have read said messages; and
c. generating reports indicating that said notifications have been read by said users.

30. The method of claim 27 further comprising the steps of:
a. displaying, on said one of more computers, manuals specifying procedures for complying with said TMSA guidelines; and
b. providing links with said manuals to forms which must be completed in support of procedures defined in said manuals, said forms having a workflow associated therewith.
